(19) United States
(12) Patent Application Publication
(10) Pub. No.: US 2016/0217534 A1
(43) Pub. Date: Jul. 28, 2016

(54) METHOD AND SYSTEM FOR IDENTIFYING SOURCES OF TAX-RELATED INFORMATION TO FACILITATE TAX RETURN PREPARATION

(71) Applicant: Intuit Inc., Mountain View, CA (US)

(72) Inventors: Jonathan R. Goldman, Mountain View, CA (US); Massimo Mascaro, San Diego, CA (US); Luis Felipe Cabrera, Bellevue, WA (US); William T. Laaser, Palo Alto, CA (US)

(73) Assignee: INTUIT INC., Mountain View, CA (US)

(21) Appl. No.: 14/607,763

(22) Filed: Jan. 28, 2015

(51) Int. Cl. G06Q 40/00

(52) U.S. Cl. CPC G06Q 40/123

(57) ABSTRACT

A method and system gathers user tax data for a user, from one or more sources of tax information, to prepare the user's tax return within a tax return preparation system, in one embodiment. The method and system populate a database with relationships between existing user metadata and one or more sources of tax information, in one embodiment. The method and system analyze new user metadata for the user to identify which of the one or more sources of tax information are relevant to the user, in one embodiment. The method and system retrieve new user tax data from the identified ones of the one or more sources of tax information that are relevant to the new user metadata of the user, in one embodiment. The method and system populate the user's tax return with the new user data, within the tax return preparation system, in one embodiment.

### BACKGROUND

Federal and State Tax law has become so complex that it is now estimated that each year Americans alone use over 6 billion person hours, and spend nearly 4 billion dollars, in an effort to comply with Federal and State Tax statutes. Given this level of complexity and cost, it is not surprising that more and more taxpayers find it necessary to obtain help, in one form or another, to prepare their taxes. Tax return preparation systems, such as tax return preparation software programs and applications, represent a potentially flexible, highly accessible, and affordable source of tax preparation assistance. However, even when using traditional tax return preparation systems, the user of the traditional tax return preparation system must expend a great deal of effort to gather and input the information needed for the traditional tax return preparation system to perform its function.

For instance, traditional tax return preparation systems often present series of questions that help the user identify which tax-related documents the user needs to complete the user's tax return. However, it is often up to the user to seek out the companies or financial institutions that maintain the user's tax-related documents. It is then up to the user to obtain, e.g., download or request, copies of the tax-related documents. Once the user obtains the tax-related documents, the user's task is still not complete because the user is then typically required to enter the information from the tax-related documents into the traditional tax return preparation system. Truly, tax return preparation can be an arduous, frustrating, and time-consuming task for a user, even when equipped with a tax return preparation system.

What is needed is a method and system for identifying sources of user tax data, automating the retrieval of user tax data from the sources of user tax data, to populate or pre-populate a user's tax return within a tax return preparation system to reduce the time and effort expended by a user in the preparation of the user's tax return.

### SUMMARY

Embodiments of the present disclosure address some of the shortcomings associated with traditional tax return preparation systems by gathering tax information or tax data from sources of tax information, without the user requesting the tax information or tax data from the sources, to facilitate the preparation of a user's tax return with a tax return preparation system. In other words, the disclosed tax preparation system preemptively gathers tax information or tax data from one or more sources of tax information to facilitate the preparation of a user's tax return with a tax return preparation system, according to one embodiment. To preemptively gather tax information for the user, the tax return preparation system analyzes user metadata, determines which sources of tax information include tax information for filling out a user's tax return, and retrieves the tax information without the user requesting that the system do so, according to one embodiment. In fact, the tax return preparation system can be configured to request or acquire tax information for completing a user's tax return from sources of tax information, before the user even knows or understands which tax information to gather or which sources of tax information to request the tax information from, according to one embodiment. By preemptively determining sources of tax information for the user and/or by preemptively requesting/acquiring the tax information that enables processing of the user's tax return, the tax return preparation system saves the user time and prevents the user from having to undertake the unpleasant experience of requesting, locating, and/or entering tax information, such as, but not limited to, W-2 information, 1099 information, federal taxes paid, state taxes paid, property taxes paid, medical expenses paid, unemployment benefits received, dividend or interest income received, retirement benefits receive, and the like, according to various embodiments.

The tax return preparation system employs a variety of techniques for preemptively gathering tax information for a user, according to one embodiment. The tax return preparation system preemptively gathers tax information for a user by populating a database with relationships (e.g., correlations or other logical or mathematical associations) between sources of tax information and existing (or historical) user metadata, receiving new user metadata, analyzing the new user metadata to determine which sources of tax information are relevant to the user, retrieving new user tax information from the relevant sources of tax information, and populating the user's tax return with the new user tax information, according to one embodiment. The metadata is data that is not directly applicable to completing a tax return. The user metadata is useful for identifying which sources of tax information may have tax information that is useful to the user for completing the user's tax return, according to one embodiment. The user metadata may include the source of tax information, according to one embodiment. Analysis of the user metadata provides indicators that are useful for identifying sources of tax information, according to one embodiment. The user metadata may be directly or indirectly obtained from the user, according to one embodiment. The user metadata includes the user's geographic location, according to one embodiment. The user metadata includes the industry in which the user works, according to one embodiment. The user metadata includes the job function of the user, according to one embodiment. The user metadata includes the user's educational background, according to one embodiment. The user metadata includes the user's age, according to one embodiment. The user metadata includes the user's work history, according to one embodiment. The user metadata includes information about the user's family, e.g., marital status, number of children, age of children, etc., according to one embodiment. The user metadata is derived without intervention, instruction, request, awareness, or knowledge of the user, e.g., preemptively, according to one embodiment. The analysis between the sources of tax information and historic or new user metadata is performed using predictive models, e.g., clustering, classification, decision trees, etc., according to one embodiment. The analysis is performed using collaborative filtering, e.g., identifying other users that share common characteristics and identifying the values they have entered for the fields of interest, according to one embodiment. The analysis may involve human involvement to choose and compare analysis techniques, according to one embodiment. The analysis may involve the selection of parameters for a chosen analytic technique. The analysis may involve training an analytic model using computer learning, according to one embodiment.

Embodiments of the present disclosure address some of the shortcomings associated with traditional tax return preparation systems by preemptively gathering user tax data from various sources of user tax data, based on the receipt, detection, or identification of user metadata, and using the gathered user tax data to populate the user's tax return, according to one embodiment. The various embodiments of the disclosure can be implemented to improve the technical fields of user experience, automated tax return preparation, data collection, and data processing. Therefore, the various described embodiments of the disclosure and their associated benefits amount to significantly more than an abstract idea. In particular, by gathering user tax data from sources of user tax data without the user's knowledge and/or without receiving a request to do so from the user, a tax return preparation system/application eliminates the traditional requirement that a user: identify documents needed to prepare a tax return, identify which sources to retrieve the needed documents from, request/download the documents, and enter information from the documents into a tax return preparation system, according to one embodiment.

In addition, as noted above, by reducing, or potentially eliminating, the processing and presentation of questions associated with assisting a user in identifying, retrieving, and entering information from tax-related documents, implementation of embodiments of the present disclosure allows for significant improvement to the field of data collection and data processing. As one illustrative example, by reducing, or potentially eliminating, the processing and presentation of questions associated with assisting a user in identifying, retrieving, and entering information from tax-related documents, implementation of embodiments of the present disclosure allows for relevant data collection using fewer processing cycles and less communications bandwidth. As a result, embodiments of the present disclosure allow for improved processor performance, more efficient use of memory access and data storage capabilities, reduced communication channel bandwidth utilization, and faster communications connections. Consequently, computing and communication systems implementing and/or providing the embodiments of the present disclosure are transformed into faster and more operationally efficient devices and systems.

### BRIEF DESCRIPTION OF THE DRAWINGS

FIG. 1 is a block diagram of software architecture for gathering user tax information from one or more sources of tax information to populate a user's tax return with a tax return preparation system, in accordance with one embodiment.

FIG. 2 is a block diagram of a process for gathering user tax information from one or more sources of user tax information for populating a user's tax return within a tax return preparation system, in accordance with one embodiment.

FIG. 3 is a flow diagram for gathering tax information, for a user, from one or more sources of tax information, to prepare a tax return of the user within a tax return preparation system, in accordance with one embodiment.

Common reference numerals are used throughout the FIGs. and the detailed description to indicate like elements. One skilled in the art will readily recognize that the above FIGs. are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIGs., which depict one or more exemplary embodiments. Embodiments may be implemented in many different forms and should not be construed as limited to the embodiments set forth herein, shown in the FIGs., and/or described below. Rather, these exemplary embodiments are provided to allow a complete disclosure that conveys the principles of the invention, as set forth in the claims, to those of skill in the art.

The INTRODUCTORY SYSTEM, HARDWARE ARCHITECTURE, and PROCESS sections herein describe systems and processes suitable for preemptively gathering tax information or tax data from sources of tax information, e.g., without the user requesting the tax information or tax data from the sources, to facilitate the preparation of a user's tax return with a tax return preparation system, according to various embodiments.

### Introductory System

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as one or more virtual assets.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system.

As used herein, the term “relationship(s)” includes, but is not limited to, a logical, mathematical, statistical, or other association between one set or group of information, data, and/or users and another set or group of information, data, and/or users, according to one embodiment. The relationships between the sets or groups can include various logical, mathematical, or statistical association, such as, but not limited to, one-to-one, multiple-to-one, one-to-multiple, multiple-to-multiple, and the like, according to one embodiment. As a non-limiting example, if the disclosed tax return preparation system determines a relationship between a first group of data and a second group of data, then a characteristic or subset of a first group of data can be related to, associated with, and/or correspond to one or more characteristics or subsets of the second group of data, or vice-versa, according to one embodiment. Therefore, relationships may represent that one or more subsets of a second group of data are associated with one or more subsets of the first group of data, according to one embodiment. In one embodiment, a relationship between two sets or groups of data includes, but is not limited to similarities, differences, a correlation, and/or other mathematical, statistical, or logical associations between the sets or groups of data.

As used herein, the terms “interview” and “interview process” include, but are not limited to, an electronic, software-based, and/or automated delivery of multiple questions to a user and an electronic, software-based, and/or automated receipt of responses from the user to the questions, to progress a user through one or more groups or topics of questions, according to various embodiments.

As used herein, the term “user experience” includes not only the interview process, interview process questioning, and interview process questioning sequence, but also other user experience features provided or displayed to the user such as, but not limited to, interfaces, images, assistance resources, backgrounds, avatars, highlighting mechanisms, icons, and any other features that individually, or in combination, create a user experience, as discussed herein, and/or as known in the art at the time of filing, and/or as developed after the time of filing.

### Hardware Architecture

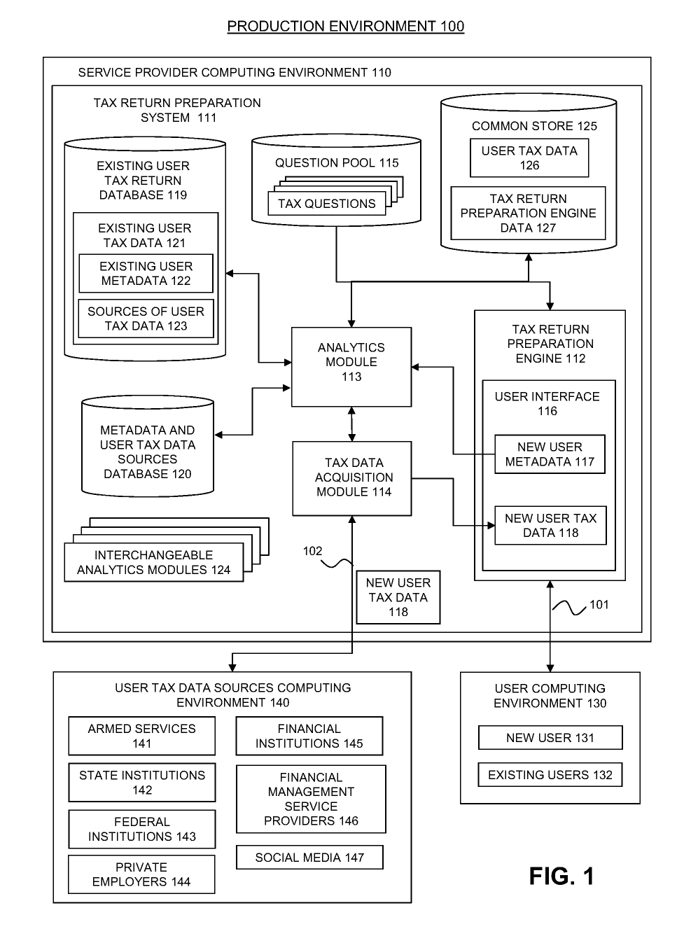

FIG. 1 illustrates a block diagram of a production environment 100 that preemptively gathers tax information or tax data from one or more sources of tax information to populate a user's tax return within a tax return preparation system, according to one embodiment. To preemptively gather tax information for the user, the production environment 100 proactively determines which sources of tax information include tax information for filling out a user's tax return, and retrieves the tax information without being requested to do so by the user, according to one embodiment. In fact, the tax return preparation system can be configured to request or acquire tax information for completing a user's tax return from sources of tax information, before the user even knows or understands which tax information to gather or which sources of tax information to request the tax information from, according to one embodiment. By preemptively determining sources of tax information for the user and/or by preemptively requesting/acquiring the tax information that enables processing of the user's tax return, the tax return preparation system saves the user time and prevents the user from having to undertake the unpleasant experience of requesting, locating, and/or entering tax information, such as, but not limited to, W-2 information, 1099 information, federal taxes paid, state taxes paid, property taxes paid, medical expenses paid, unemployment benefits received, dividend or interest income received, retirement benefits receive, and the like, according to various embodiments. A tax return preparation system preemptively gathers tax information for a user by populating a database that includes relationships (e.g., correlations or other logical or mathematical associations) between sources of tax information and existing (or historical) user metadata, receiving new user metadata, analyzing the new user metadata to determine which sources of tax information are relevant to the user, retrieving new user tax information from the relevant sources of tax information, and populating the user's tax return with the new user tax information, according to one embodiment. Various additional embodiments are disclosed below in the context of the tax return preparation system.

Embodiments of the present disclosure address some of the shortcomings associated with traditional tax return preparation systems by preemptively gathering user tax data from various sources of user tax data, based on the receipt, detection, or identification of user metadata, and using the gathered user tax data to populate the user's tax return, according to one embodiment. The various embodiments of the disclosure can be implemented to improve the technical fields of user experience, automated tax return preparation, data collection, and data processing. Therefore, the various described embodiments of the disclosure and their associated benefits amount to significantly more than an abstract idea. In particular, by gathering user tax data from sources of user tax data without the user's knowledge and/or without receiving a request to do so from the user, a tax return preparation system/application eliminates the traditional requirement that a user: identify documents needed to prepare a tax return, identify which sources to retrieve the needed documents from, request/download the documents, and enter information from the documents into a tax return preparation system, according to one embodiment.

In addition, as noted above, by reducing, or potentially eliminating, the processing and presentation of questions associated with assisting a user in identifying, retrieving, and entering information from tax-related documents, implementation of embodiments of the present disclosure allows for significant improvement to the field of data collection and data processing. As one illustrative example, by reducing, or potentially eliminating, the processing and presentation of questions associated with assisting a user in identifying, retrieving, and entering information from tax-related documents, implementation of embodiments of the present disclosure allows for relevant data collection using fewer processing cycles and less communications bandwidth. As a result, embodiments of the present disclosure allow for improved processor performance, more efficient use of memory access and data storage capabilities, reduced communication channel bandwidth utilization, and faster communications connections. Consequently, computing and communication systems implementing and/or providing the embodiments of the present disclosure are transformed into faster and more operationally efficient devices and systems.

The production environment 100 includes a service provider computing environment 110, a user computing environment 130, and a user tax data sources computing environment 140 for preemptively, e.g., without a request from or knowledge of a user, gathering user tax data from sources of user tax data for processing a user's tax return in a tax return preparation system, according to one embodiment. The computing environments 110, 130, and 140 are communicatively coupled to each other with a communication channel 101 and a communication channel 102, according to one embodiment.

The service provider computing environment 110 represents one or more computing systems such as a server, a computing cabinet, and/or distribution center that is configured to receive, execute, and host one or more tax return preparation systems (e.g., applications) for access by one or more users, e.g., tax filers and/or system administrators, according to one embodiment.

The service provider computing environment 110 includes a tax return preparation system 111 to determine which sources of user tax data are relevant to a user, based on the user's metadata, retrieve user tax data from the relevant sources, and populates the user's tax return with the retrieved user tax data, according to one embodiment. The tax return preparation system 111 uses the retrieved user tax data to prepare the user's tax return, while reducing the burden on the user to wait for, retrieve, and enter user tax data for the tax return preparation system 111, according to one embodiment. The tax return preparation system 111 includes various components, databases, engines, modules, and/or data to support preemptively gathering user tax data from sources of user tax data for the preparation of the user's tax return, according to one embodiment.

The tax return preparation system 111 includes a tax return preparation engine 112 for progressing a user through a tax return preparation interview, an analytics module 113 for determining which sources of user tax data are relevant to a user based on the user's metadata, and a tax data acquisition module 114 for retrieving the user tax data from the relevant sources of user tax data, according to one embodiment.

The tax return preparation engine 112 guides the user through the tax return preparation process by presenting the user with tax questions from a question pool 115, according to one embodiment. The tax return preparation engine 112 includes a user interface 116, which includes one or more user experience elements and graphical user interface tools, such as, but not limited to, buttons, slides, dialog boxes, text boxes, drop-down menus, banners, tabs, directory trees, links, audio content, video content, and/or other multimedia content for communicating information to the user computing environment 130 and for receiving information from the user computing environment 130, according to one embodiment.

The user computing environment 130 includes a new user 131 and existing users 132, according to one embodiment. The new user 131 is a first user, and the existing users 132 are second users, according to one embodiment. The new user 131 is different from the existing users 132, in that the tax return preparation system 111 already includes or stores user tax data for the existing users 132, according to one embodiment. By contrast, and user 131 has yet to prepare or complete the preparation of the new user's tax return, according to one embodiment. The user computing environment 130 is illustrated as a single computing environment, but it is to be understood that the user computing environment 130 represents any computing system used by previous users, current users, new users, and/or future users of the tax return preparation system 111, according to one embodiment.

The tax return preparation system 111 uses new user metadata 117 to retrieve new user tax data 118, according to one embodiment. The tax return preparation engine 112 uses the user interface 116 to receive the new user metadata 117 from the new user 131, according to one embodiment. The tax return preparation system 111 determines the new user metadata 117 directly or indirectly based on information the new user 131 provides to the tax return preparation system 111, according to one embodiment. The tax return preparation engine 112 provides the new user metadata 117 to the analytics module 113, and the analytics module 113 determines which sources of user tax data to query in order to retrieve the new user tax data 118, according to one embodiment. The tax return preparation engine 112 uses the retrieved new user tax data 118 to populate the user's tax return to facilitate tax return preparation for the user, according to one embodiment.

The analytics module 113 performs at least two functions within the tax return preparation system 111, according to one embodiment. First, the analytics module 113 uses information from the existing user tax return database 119 to populate a metadata and user tax data sources database 120, by determining relationships between existing user metadata and sources of user tax data, according to one embodiment. Second, the analytics module 113 analyzes the new user metadata 117 with the metadata and user tax data sources database 120 to determine which sources of user tax data contain or may contain the new user tax data 118 that can be used for populating and preparing the tax return of the new user 131, according to one embodiment.

The analytics module 113 populates the metadata and user tax data sources into database 120 using information that is stored in the existing user tax return database 119, according to one embodiment. The existing user tax return database 119 includes existing user tax data 121 from the existing users 132, e.g., users from previous years, or users from the current year who have completed their tax return, according to one embodiment. The analytics module 113 uses the existing user tax data 121 to determine existing user metadata 122 and sources of user tax data 123, according to one embodiment. Alternatively, in one embodiment, the existing user metadata 122 is not determined from the existing user tax data 121, and the existing user tax return database 119 stores the existing user metadata 122 and sources of user tax data 123 separately and/or independently of the existing user tax data 121. The analytics module 113 also determines the relationships or associations (e.g., the correlation) between the existing user metadata 122 and the sources of user tax data 123 and saves the relationships in the metadata and user tax data sources database 120, according to one embodiment. The analytics module 113 then uses the metadata and user tax data sources database 120 to determine which sources of user data are relevant to the new user metadata 117, in order to facilitate the request and retrieval of the new user tax data 118, according to one embodiment.

The user metadata within the tax return preparation system 111 is different than the user tax data within the tax return preparation system 111, according to one embodiment. The user tax data (new or existing) is data that is used for populating a user's tax return, according to one embodiment. By contrast, the user metadata (new or existing) is information about the user, which may be extracted from or extrapolated from user tax data, and which is not data that is directly used for populating a user's tax return, according to one embodiment. In other words, the user metadata is data that is not directly applicable to completing or filling out a tax return, according to one embodiment. However, the user metadata is used by the analytics module 113 to identify which sources of user tax data may have tax information that can be used by the tax return preparation system 111 to prepare the user's tax return, according to one embodiment.

The user metadata 117, 122 (i.e., new and existing user metadata) includes information that is collected directly and/or indirectly from a user or about the user, according to one embodiment. The user metadata 117, 122 includes, but is not limited to, a driver's license number, a job title, an employer's address, an occupation, website browsing preferences of the user, a typical lingering duration on a website, information regarding dependents of the user, clickstream information, information obtained from website advertisers or Internet analytics companies, a job function of the user, the user's educational background, the user's age, the user's work history, information about the user's family (e.g., marital status, number of children, age of children, etc.), the industry in which the user works, the user's geographic location, the users Internet Protocol (“IP”) address, and the like, according to one embodiment. In one embodiment, the user metadata 117, 122 is derived without the user's knowledge and/or without assistance from the user.

The user tax data 118, 121 (i.e., new and existing user tax data) includes information collected directly and/or indirectly from the user, according to one embodiment. The user tax data 118, 121 includes information, such as, but not limited to, a name, a Social Security number, a government identification, a date of birth, an address, a zip code, home ownership status, marital status, annual income, W-2 income, 1099 income, spousal information, children's information, asset information, medical history, salary and wages, interest income, dividend income, business income, farm income, capital gain income, pension income, IRA distributions, unemployment compensation, education expenses, health savings account deductions, moving expenses, IRA deductions, student loan interest deductions, tuition and fees, medical and dental expenses, state and local taxes, real estate taxes, personal property tax, mortgage interest, charitable contributions, casualty and theft losses, unreimbursed employee expenses, alternative minimum tax, foreign tax credit, education tax credits, retirement savings contribution, child tax credits, residential energy credits, and any other information that is currently entered, that can be entered into a tax return in preparation for filing with one or more government entities, according to various embodiments.

The analytics module 113 can use a variety of techniques to determine, identify, or extract the existing user metadata 122 from the existing user tax data 121, according to one embodiment. For example, the analytics module 113 uses a zip code or address from the existing user tax data 121 to determine existing user metadata 122, such as a general geographic region in which the user resides. Then, based on the general geographic region which the user resides, i.e., the user metadata, the analytics module 113 can determine that the likelihood that the user is a homeowner is high, and the analytics module 113 can identify a county treasurer website as a source of user tax data from which to retrieve an amount of property taxes that was paid by the user during a tax year of interest, according to one embodiment. As another example, the analytics module 113 can use income information from the existing user metadata 122 to determine if the user's income is above a predetermined threshold, e.g., user metadata. If the user's income is above a predetermined threshold, the analytics module 113 can determine that the user is likely to have one or more brokerage accounts for which the user has dividend income, and can identify financial institutions for the brokerage accounts as sources of user tax data from which to obtain dividend income amounts for the user for preparation of the user's tax return, according to one embodiment.

Sources of user tax data 123 can include a number of organizations, according to one embodiment. For example, the user tax data sources computing environment 140 represents one or more computing environments used by various sources of user tax data, according to one embodiment. The user tax data sources computing environment 140 includes, but is not limited to, armed services 141, state institutions 142, federal institutions 143, private employers 144, financial institutions 145, financial management service providers 146, and social media 147, as examples of sources of user tax data 123, according to one embodiment. The service provider of the tax return preparation system can enter into agreements, contracts, or other arrangements/relationships with sources of user tax data so that the tax return preparation system 111 can automatically retrieve information from one or more of the sources of user tax data for one or more users, during the preparation of the users' tax returns, according to one embodiment. The armed services 141 can include the Army, Navy, Marines, Air Force, and the like, according to one embodiment. The state institutions 142 include, but are not limited to, the department of motor vehicle, Secretary of State, educational institutions, government payroll, hospitals, and the like, according to one embodiment. The federal institutions 143 include, but are not limited to, the internal revenue service, and federal employee payroll services, according to one embodiment. Private employers 144 include, but are not limited to, Walmart, McDonald's, IBM, the United Parcel Service, Target, Kroger, the Home Depot, hospitals, education providers, and the like, according to one embodiment. The financial institutions 145 include, but are not limited to, commercial banks, investment banks, insurance companies, brokerages, investment companies, credit unions, and the like, according to one embodiment. Financial management service providers 146 include, but are not limited to, payroll companies (e.g., ADP, Intuit, Paychex, OnPay, etc.) and personal financial management service providers (e.g., Intuit), in one embodiment. Social media 137 includes, but is not limited to, LinkedIn, Facebook, Twitter, and the like, according to one embodiment. The sources of user tax data 123 can also include professional associations, such as oil, natural gas, coal, silver, or other mineral rights associations, and can also include organizations such as unions (e.g., carpenter unions, trucker unions, etc.), according to one embodiment. The sources of user tax data 123 can include any business, organization, or association that has maintained user tax data, that currently maintains user tax data, or which may in the future maintain user tax data, according to one embodiment.

The analytics module 113 determines relationships between the existing user metadata 122 and the sources of user tax data 123 by analyzing the existing user tax data 121 with one or more analytic techniques and/algorithms, according to one embodiment. In one embodiment, the relationship between the existing user metadata 122 and the sources of user tax data 123 is a correlation between the existing user metadata 122 and the sources of user tax data 123. The analytics module 113 determines the relationship between the existing user metadata 122 and the sources of user tax data 123 using predictive models, such as clustering, classification, and decision trees, according to one embodiment. The analytics module 113 determines the relationship between the existing user metadata 122 and the sources of user tax data 123 by using collaborative filtering, e.g., identifying users that share common characteristics and identifying the values entered by the user's in one or more fields of interest, according to one embodiment. The analytics module 113 determines the relationship between the existing user metadata 122 and the sources of user tax data 123 using one or more of the number of analytic techniques, and the analytic techniques used are at least partially based on characteristics of users and/or characteristics of existing user tax data 121, according to one embodiment. In one embodiment, a systems administrator, analytics specialist, or other human resource evaluates the results of the different analytics techniques, and configures the analytics module 113 to use a particular analytic technique based on the analysis of the human resource, according to one embodiment. In one embodiment, the analytic technique or algorithm includes a model produced by using one or more computer learning or computer training techniques, for determining the relationship between the existing user metadata and the sources of user tax data 123, according to one embodiment. In one embodiment, the analytics module 113 is interchangeable with any one of the interchangeable analytics modules 124, by the tax return preparation system 111, to apply one or more different analytics techniques or algorithms to the user metadata 117, 122.

The analytics module 113 stores the relationships between the existing user metadata 122 and the sources of user tax data 123 in the metadata and user tax data sources database 120, according to one embodiment. The metadata and user tax data sources database 120 is a number of tables, or other data structures, that are searchable, and that can be organized and filtered, while storing relationships between the existing user metadata 122 and the sources of user tax data 123, according to one embodiment.

The analytics module 113 identifies which of the sources of user tax data 123 are applicable to the new user metadata 117, according to one embodiment. The analytics module 113 receives the new user metadata 117 from the tax return preparation engine 112, for the new user 131, according to one embodiment. The analytics module 113 then uses the metadata and user tax data sources database 120 to identify one or more sources of user tax data 123 that are associated with the new user metadata 117, according to one embodiment. Once the analytics module 113 has identified relevant sources of user tax data, the analytics module 113 uses the tax data acquisition module 114 to retrieve the new user tax data 118, according to one embodiment.

The tax data acquisition module 114 receives identified sources of user tax data from the analytics module 113 and retrieves the new user tax data 118 from the identified sources of user tax data, according to one embodiment. In one embodiment, the tax data acquisition module 114 is a separate module from the analytics module 113. In another embodiment, the functionality of the tax data acquisition module 114 is included into the analytics module 113, is included in the tax return preparation engine 112, or is included in another module or component within the tax return preparation system 111, according to various embodiments. The tax data acquisition module 114 transmits requests to the user tax data sources computing environment 140, e.g., one or more servers for the sources of user tax data, for the new user tax data 118 that is related to or associated with the new user metadata 117 of the new user 131, according to one embodiment. The tax data acquisition module 114 receives the new user tax data 118 through one or more networks or communication channels, e.g., the communication channel 102, from the sources of user tax data 123, e.g., from the financial management service providers 146, according to one embodiment.

The tax data acquisition module 114 provides the new user tax data 118 to the analytics module 113 and to the tax return preparation engine 112, according to one embodiment. The tax data acquisition module 114 provides the new user tax data 118 to the analytics module 113 so that the analytics module 113 can update the existing user tax return database 119 and/or the metadata and user tax data sources database 120, according to one embodiment. The tax data acquisition module 114 provides the new user tax data 118 to the tax return preparation engine 112 so that the user interface 116 can display the new user tax data 118 to the user, for confirmation that the new user tax data 118 is correct and belongs to the user, according to one embodiment. For example, the user interface 116 can be configured to provide a partial view of the new user tax data 118 to the new user 131 and query the new user 131 as to whether or not the new user tax data 118 belongs to the new user 131, according to one embodiment.

The tax data acquisition module 114 also provides the new user tax data 118 to the tax return preparation engine 112 so that the tax return preparation engine 112 can use the new user tax data 118 to populate the tax return of the new user 131, according to one embodiment. By populating or pre-populating the tax return of the new user 131, the tax return preparation system 111 can save the new user 131, and subsequent users of the tax return preparation system 111, significant amounts of time, according to one embodiment. For example, because of the ability of the tax return preparation system 111 to identify, requests, and retrieve the new user tax data 118, the new user 131 may not have to identify sources of user tax data, identify documents that contain the user's tax data, search through the identified documents that contain the user's tax data, or enter in the user's tax data from the identified documents that contain the user's tax data, according to one embodiment. The ability of the tax return preparation system 111 to preemptively identify sources of user tax data, retrieve the user tax data, and pre-populate the user's tax return with the retrieved user tax data can truly turn a relatively frustrating and time-consuming process into a few clicks of a mouse button, according to one embodiment.

According to one embodiment, the components within the tax return preparation system 111 communicate with each other using API functions, routines, and/or calls. However, according to another embodiment, the analytics module 113, the tax return preparation engine 112, and other functional modules/components can use a common store 125 for sharing, communicating, or otherwise delivering information between different features or components within the tax return preparation system 111. The common store 125 includes, but is not limited to, user tax data 126 (inclusive of some of the new user tax data 118 and the existing user tax data 121) and tax return preparation engine data 127, according to one embodiment. The analytics module 113 can be configured to store information and retrieve information from the common store 125 independent of information retrieved from and stored to the common store 125 by the tax return preparation engine 112, according to one embodiment. In addition to the analytics module 113 and the tax return preparation engine 112, other components within the tax return preparation system 111 and other computer environments may be granted access to the common store 125 to facilitate communications with the analytics module 113 and/or the tax return preparation engine 112, according to one embodiment.

A number of examples could be provided to illustrate the utility of the disclosed embodiments of the tax return preparation system 111. For example, if the user's metadata indicates that the user has a car, the tax return preparation system 111 can be configured to access a department of motor vehicle server to get registration proof for the vehicle to supply proof for a registration deduction in the user's tax return, according to one embodiment. As another example, if the user's metadata indicates that the user has changed jobs, the tax return preparation system 111 can be configured to access a social media server, such as LinkedIn, to determine whether to search for a W-2 or for 1099 user data, according to one embodiment. As yet another example, if the user's metadata indicates that the user has been employed as a teacher, the tax return preparation system can be configured to search one or more personal financial management service provider servers to determine how much in non-reimbursed expenses to include in the user's tax return, according to one embodiment.

As described above, the production environment 100 preemptively gathers tax information for the user to reduce the time invested in the preparation of the user's tax return, and to reduce the amount of effort put forth by the user to prepare the user's tax return, according to one embodiment. Unlike traditional tax return preparation systems, the tax return preparation system 111 can reduce confusion, frustration, and trust issues of users of tax return preparation systems by gathering and pre-populating the user's tax return with the user's tax data, without waiting for the user to enter the information into the tax return and/or without waiting for the user to request the retrieval of the user's tax data, according to one embodiment. The tax return preparation system 111 retrieves the user tax data and pre-populates the user's tax return with the user tax data based on user metadata, user characteristics, and/or minor amounts of information entered into the tax return preparation system 111, by the user, according to one embodiment.

Embodiments of the present disclosure address some of the shortcomings associated with traditional tax return preparation systems by preemptively gathering user tax data from various sources of user tax data, based on the receipt, detection, or identification of user metadata, and using the gathered user tax data to populate the user's tax return, according to one embodiment. The various embodiments of the disclosure can be implemented to improve the technical fields of user experience, automated tax return preparation, data collection, and data processing. Therefore, the various described embodiments of the disclosure and their associated benefits amount to significantly more than an abstract idea. In particular, by gathering user tax data from sources of user tax data without the user's knowledge and/or without receiving a request to do so from the user, a tax return preparation system/application eliminates the traditional requirement that a user: identify documents needed to prepare a tax return, identify which sources to retrieve the needed documents from, request/download the documents, and enter information from the documents into a tax return preparation system, according to one embodiment.

In addition, as noted above, by reducing, or potentially eliminating, the processing and presentation of questions associated with assisting a user in identifying, retrieving, and entering information from tax-related documents, implementation of embodiments of the present disclosure allows for significant improvement to the field of data collection and data processing. As one illustrative example, by reducing, or potentially eliminating, the processing and presentation of questions associated with assisting a user in identifying, retrieving, and entering information from tax-related documents, implementation of embodiments of the present disclosure allows for relevant data collection using fewer processing cycles and less communications bandwidth. As a result, embodiments of the present disclosure allow for improved processor performance, more efficient use of memory access and data storage capabilities, reduced communication channel bandwidth utilization, and faster communications connections. Consequently, computing and communication systems implementing and/or providing the embodiments of the present disclosure are transformed into faster and more operationally efficient devices and systems.

### Process

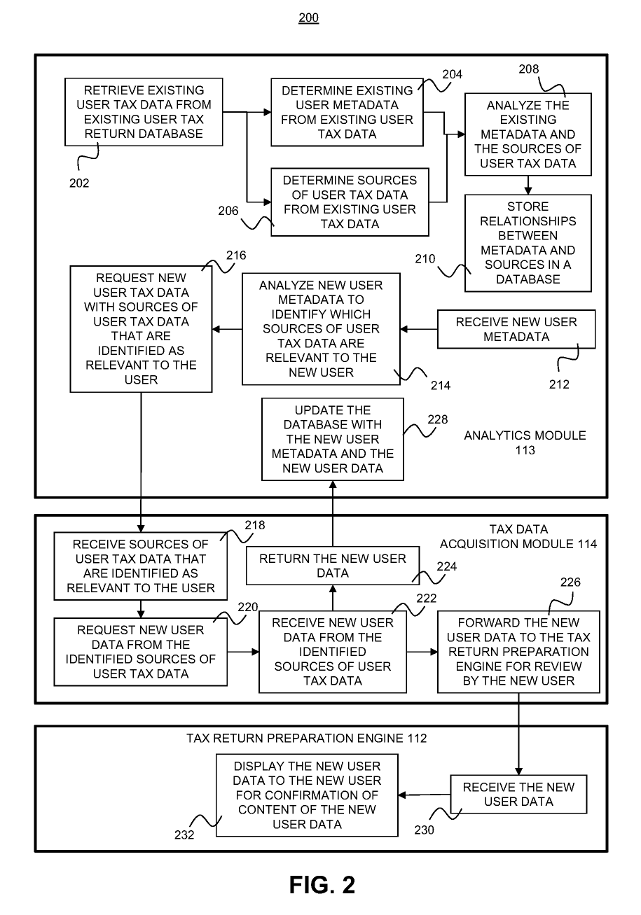

FIG. 2 illustrates a functional flow diagram of a process 200 for gathering user tax data from one or more sources of user tax data for populating a user's tax return within a tax return preparation system, according to one embodiment.

At block 202, the analytics module 113 retrieves existing user tax data from the existing user tax return database, according to one embodiment. The existing user tax return database stores and/or maintains tax return information for users who have already completed their tax returns in a current year or who have completed their tax returns and one or more previous years, according to one embodiment. Thus, “existing” user tax returns are reference to any information associated with tax returns that have already been completed and/or are stored within the tax return preparation system 111, according to one embodiment.

At block 204, the analytics module 113 determines existing user metadata from existing user tax data, according to one embodiment. In other words, the analytics module 113 identifies any user metadata that is included in user tax data that is stored within the tax return preparation system 111 for tax returns that have already been completed, according to one embodiment.

At block 206, the analytics module 113 determines sources of user tax data from the existing user tax data, according to one embodiment. For example, if the existing user tax data includes dividend income, property taxes, and/or armed services retirement income, the analytics module 113 can identify sources of user tax data such as a brokerage, a county property tax web site/server, and/or an armed services payroll server, according to one embodiment.

At block 208, the analytics module 113 analyzes the existing user metadata and the sources of user tax data, according to one embodiment. The analytics module 113 uses one or more predictive models (e.g., clustering, classification, decision trees, etc.), collaborative filters, and/or other data analysis techniques for determining the relationships (e.g., the correlation or other logical association) between existing user metadata and sources of user tax data, according to one embodiment.

At block 210, the analytics module 113 stores the relationship between the user metadata and sources of user tax data in a database, according to one embodiment.

At block 212, the analytics module 113 receives new user metadata, according to one embodiment. The analytics module 113 can receive the new user metadata from the tax return preparation engine or from some other module component within the tax return preparation system 111, according to one embodiment.

At block 214, the analytics module 113 analyzes the new user metadata to identify which sources of user tax data are relevant to the new user, according to one embodiment. The analytics module 113 may analyze the new user metadata by applying the new user metadata to one or more databases in which relationships between user metadata and sources of user tax data are stored, according to one embodiment.

At block 216, the analytics module 113 requests new user tax data from the sources of user tax data that are identified as relevant to the user, according to one embodiment. The analytics module 113 can be configured to request the new user tax data directly from the sources of the user tax data, or can be configured to use the tax data acquisition module 114, according to one embodiment.

At block 218, the tax data acquisition module 114 receives sources of user tax data that are identified as relevant to the user, according to one embodiment.

At block 220, the tax data acquisition module 114 requests the new user data from the identified sources of user tax data, according to one embodiment. The sources of user tax data include, but are not limited to, armed services, state institutions, federal institutions, private employers, financial institutions, financial management service providers, social media, professional associations, and other private organizations and associations, according to one embodiment.

At block 222, the tax data acquisition module 114 receives the new user data from the identified sources of user tax data, according to one embodiment. From block 222, the process proceeds to block 224 and to block 226, according to one embodiment.

At block 224, the tax data acquisition module returns the new user data to the analytics module, according to one embodiment.

At block 228, the analytics module 113 updates the database with the new user metadata and the new user data, according to one embodiment.

At block 226, the tax data acquisition module 114 forwards the new user data to the tax return preparation engine for review by the user, according to one embodiment.

At block 230, the tax return preparation engine 112 receives the new user data, according to one embodiment.

At block 232, the tax return preparation engine 112 displays the new user data to the new user for confirmation of the content of the new user data, according to one embodiment. The tax return preparation engine 112 is also configured to populate or pre-populate the user's tax return with the new user data, according to one embodiment.

Although a particular sequence is described herein for the execution of the process 200, other sequences can also be implemented, according to other embodiments.

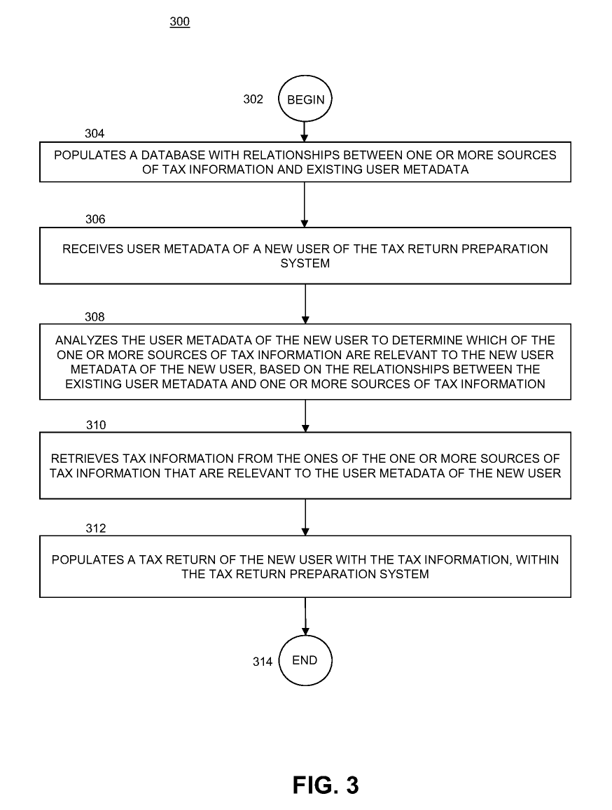

FIG. 3 illustrates a flow diagram of a process 300 for gathering tax information, for a user, from one or more sources of tax information, to prepare a tax return of the user within a tax return preparation system, according to various embodiments.

At block 302, the process begins.

At block 304, the process populates a database with relationships between one or more sources of tax information and existing user metadata, according to one embodiment. The existing user metadata is metadata of multiple users who have completed tax returns with a tax return preparation system, according one embodiment.

A block 306, the process receives user metadata of a new user of the tax return preparation system, according to one embodiment.

At block 308, the process analyzes the user metadata of the new user to determine which of the one or more sources of tax information are relevant to the new user metadata of the new user, based on the relationships between the existing user metadata and the one or more sources of tax information, according to one embodiment.

At block 310, the process retrieves tax information from the ones of the one or more sources of tax information that are relevant to the user metadata of the new user, according to one embodiment.

At block 312, the process populates a tax return of the new user with the tax information, within the tax return preparation system, according to one embodiment.

At block 314, the process ends.

As noted above, the specific illustrative examples discussed above are but illustrative examples of implementations of embodiments of the method or process for individualizing the tax return preparation interview with an interchangeable, e.g., modular, analytics module. Those of skill in the art will readily recognize that other implementations and embodiments are possible. Therefore the discussion above should not be construed as a limitation on the claims provided below.

In accordance with one embodiment, a computing system implemented method gathers user tax data for a user, from one or more sources of tax information, to prepare a tax return of the user within a tax return preparation system. The method includes populating a database with relationships between existing user metadata and one or more sources of tax information, according to one embodiment. The existing user metadata is metadata of multiple users who have completed tax returns with a tax return preparation system, according to one embodiment. The method includes receiving new user metadata for a new user of the tax return preparation system, according to one embodiment. The method includes analyzing the new user metadata for the new user to identify which of the one or more sources of tax information are relevant to the new user metadata of the new user, based on the relationships between the existing user metadata and the one or more sources of tax information, according to one embodiment. The method includes retrieving new user tax data from the identified ones of the one or more sources of tax information that are relevant to the new user metadata of the new user, according to one embodiment. The method includes populating a tax return of the new user with the new user data, within the tax return preparation system, according to one embodiment.

In accordance with one embodiment, a computer-readable medium has a plurality of computer-executable instructions which, when executed by a processor, perform a method for gathering user tax data for a user, from one or more sources of tax information, to facilitate a preparation of a tax return for the user within a tax return preparation system. The instructions include a tax return data structure configured to store existing user tax data, according to one embodiment. The existing user tax data includes information from tax returns that have been completed by multiple users of a tax return preparation system, according to one embodiment. The instructions include a data structure configured to store relationships between existing user metadata and one or more sources of tax information, according to one embodiment. The instructions include an analytics module configured to determine the relationships between the existing user metadata and the sources of tax information that are stored in the data structure, according to one embodiment. The analytics module is configured to determine a relationship between new user metadata and the one or more sources of tax information, according to one embodiment. The instructions include a tax data acquisition module configured to retrieve new user tax data from those of the one or more sources of tax information which are relevant to the new user metadata, according to one embodiment. The instructions include a tax return preparation engine configured to populate a tax return of a new user with the new user tax data that is retrieved based on the new user metadata, according to one embodiment.

In accordance with one embodiment, a system gathers user tax data for a user, from one or more sources of tax information, to prepare a tax return of the user within a tax return preparation system. The system includes at least one processor and at least one memory coupled to the at least one processor, according to one embodiment. The at least one memory includes instructions which, when executed by any set of the one or more processors, perform a process for gathering user tax data for a user, from one or more sources of tax information, to prepare a tax return of the user within a tax return preparation system. The process includes populating a database with relationships between existing user metadata and one or more sources of tax information, according to one embodiment. The existing user metadata is metadata of multiple users who have completed tax returns with a tax return preparation system, according to one embodiment. The process includes receiving new user metadata for a new user of the tax return preparation system, according to one embodiment. The process includes analyzing the new user metadata for the new user to identify which of the one or more sources of tax information are relevant to the new user metadata of the new user, based on the relationships between the existing user metadata and the one or more sources of tax information, according to one embodiment. The process includes retrieving new user tax data from the identified ones of the one or more sources of tax information that are relevant to the new user metadata of the new user, according to one embodiment. The process includes populating a tax return of the new user with the new user data, within the tax return preparation system, according to one embodiment.

Embodiments of the present disclosure address some of the shortcomings associated with traditional tax return preparation systems by preemptively gathering user tax data from various sources of user tax data, based on the receipt, detection, or identification of user metadata, and using the gathered user tax data to populate the user's tax return, according to one embodiment. The various embodiments of the disclosure can be implemented to improve the technical fields of user experience, automated tax return preparation, data collection, and data processing. Therefore, the various described embodiments of the disclosure and their associated benefits amount to significantly more than an abstract idea. In particular, by gathering user tax data from sources of user tax data without the user's knowledge and/or without receiving a request to do so from the user, a tax return preparation system/application eliminates the traditional requirement that a user: identify documents needed to prepare a tax return, identify which sources to retrieve the needed documents from, request/download the documents, and enter information from the documents into a tax return preparation system, according to one embodiment.

In addition, as noted above, by reducing, or potentially eliminating, the processing and presentation of questions associated with assisting a user in identifying, retrieving, and entering information from tax-related documents, implementation of embodiments of the present disclosure allows for significant improvement to the field of data collection and data processing. As one illustrative example, by reducing, or potentially eliminating, the processing and presentation of questions associated with assisting a user in identifying, retrieving, and entering information from tax-related documents, implementation of embodiments of the present disclosure allows for relevant data collection using fewer processing cycles and less communications bandwidth. As a result, embodiments of the present disclosure allow for improved processor performance, more efficient use of memory access and data storage capabilities, reduced communication channel bandwidth utilization, and faster communications connections. Consequently, computing and communication systems implementing and/or providing the embodiments of the present disclosure are transformed into faster and more operationally efficient devices and systems.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIGs., or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for gathering user tax data for a user, from one or more sources of tax information, to prepare a tax return of the user within a tax return preparation system, comprising:
populating a database with relationships between existing user metadata and one or more sources of tax information,
wherein the existing user metadata is metadata of multiple users who have completed tax returns with a tax return preparation system;
receiving new user metadata for a new user of the tax return preparation system;
analyzing the new user metadata for the new user to identify which of the one or more sources of tax information are relevant to the new user metadata of the new user, based on the relationships between the existing user metadata and the one or more sources of tax information;
retrieving new user tax data from the identified ones of the one or more sources of tax information that are relevant to the new user metadata of the new user; and
populating a tax return of the new user with the new user data, within the tax return preparation system.

2. The method of claim 1, wherein retrieving the new user tax data from the identified ones of the one or more sources of tax information includes preemptively receiving the new user data.

3. The method of claim 2, wherein preemptively receiving the new user data from the identified ones of the one or more sources of tax information includes retrieving the new user tax data, without receiving a request to retrieve the new user tax data from the new user.

4. The method of claim 3, wherein preemptively receiving the new user data from the identified ones of the one or more sources of tax information includes populating the tax return of the new user with the new user data, without receiving a request from the new user to populate the tax return of the new user with the new user data.

5. The method of claim 1, wherein new user metadata excludes data that is directly input into the tax return of the new user.

6. The method of claim 1, wherein the new user metadata includes one or more of:
data indicating a geographic location of the new user;
data indicating an industry in which the new user is employed;
data indicating a job function of the new user;
data indicating an educational background of the new user;
data indicating an age of the new user;
data indicating a work history of the new user; and
data indicating information related to family members of the new user.

7. The method of claim 1, wherein the new user metadata is generated from information that is indirectly provided to the tax return preparation system by the new user.

8. The method of claim 1, wherein the new user metadata is generated from information that is directly provided to the tax return preparation system by the user.

9. The method of claim 1, wherein the new user tax data includes one or more of:
data indicating a name of the new user;
data indicating Social Security Number of the new user;
data indicating a government identification of the new user;
data indicating a date of birth of the new user;
data indicating an address of the new user;
data indicating a zip code of the new user;
data indicating a home ownership status of the new user;
data indicating a marital status of the new user;
data indicating an annual income of the new user;
data indicating an employer's address of the new user;
data indicating spousal information of the new user;
data indicating children's information of the new user;
data indicating assets of the new user;
data indicating a medical history of the new user;
data indicating an occupation of the new user;
data indicating dependents of the new user;
data indicating a salary and wages of the new user;
data indicating an interest income of the new user;
data indicating a dividend income of the new user;
data indicating a business income of the new user;
data indicating a farm income of the new user;
data indicating a capital gain income of the new user;
data indicating a pension income of the new user;
data indicating IRA distributions of the new user;
data indicating an unemployment compensation of the new user;
data indicating educator expenses of the new user;
data indicating health savings account deductions of the new user;
data indicating moving expenses of the new user;
data indicating IRA deductions of the new user;
data indicating student loan interest deductions of the new user;
data indicating tuition and fees of the new user;
data indicating medical and dental expenses of the new user;
data indicating state and local taxes of the new user;
data indicating real estate taxes of the new user;
data indicating personal property tax of the new user;
data indicating mortgage interest of the new user;
data indicating charitable contributions of the new user;
data indicating casualty and theft losses of the new user;
data indicating unreimbursed employee expenses of the new user;
data indicating an alternative minimum tax of the new user;
data indicating a foreign tax credit of the new user;
data indicating education tax credits of the new user;
data indicating retirement savings contributions of the new user;
data indicating child tax credits of the new user; and
data indicating residential energy credits of the new user.

10. The method of claim 1, wherein the one or more sources of tax information that are relevant to the new user metadata of the new user are associated, in the database, with the existing user metadata that is similar to the new user metadata.

11. The method of claim 1, wherein the multiple users have completed tax returns with the tax return preparation system for one or more previous tax years.

12. The method of claim 1, further comprising:
directing the existing user metadata and the one or more sources of tax information through an analytics algorithm to determine the relationships between the existing user metadata and one or more sources of tax information.

13. The method of claim 12, wherein the analytics algorithm includes one or more of:
a clustering predictive model;
a classification predictive model;
a decision tree predictive model;
a collaborative filter; and
a correlation model produced with a computer learning algorithm.

14. The method of claim 12, wherein the analytics algorithm is interchangeably implemented within the tax return preparation system to enable the analytics algorithm to be exchanged with one or more other analytics algorithms.

15. The method of claim 1, wherein the one or more sources of tax information include one or more of:
armed services;
state institutions;
federal institutions;
private employers;
financial institutions;
financial management service providers; and
social media.

16. A computer-readable medium having a plurality of computer-executable instructions which, when executed by a processor, perform a method for gathering user tax data for a user, from one or more sources of tax information, to facilitate a preparation of a tax return for the user within a tax return preparation system, the instructions comprising:
a tax return data structure configured to store existing user tax data,
wherein the existing user tax data includes information from tax returns that have been completed by multiple users of a tax return preparation system;
a data structure configured to store relationships between existing user metadata and one or more sources of tax information;
an analytics module configured to determine the relationships between the existing user metadata and the sources of tax information that are stored in the data structure,
wherein the analytics module is configured to determine a relationship between new user metadata and the one or more sources of tax information;
a tax data acquisition module configured to retrieve new user tax data from those of the one or more sources of tax information which are relevant to the new user metadata; and
a tax return preparation engine configured to populate a tax return of a new user with the new user tax data that is retrieved based on the new user metadata.

17. The computer-readable medium of claim 16, wherein the analytics module is configured to extract existing user metadata from the existing user tax data stored in the tax return data structure.

18. The computer-readable medium of claim 16, wherein new user metadata excludes data that is directly input into the tax return of the new user.

19. The computer-readable medium of claim 16, wherein the new user metadata includes one or more of:
data indicating a geographic location of the new user;
data indicating an industry in which the new user is employed;
data indicating a job function of the new user;
data indicating an educational background of the new user;
data indicating an age of the new user;
data indicating a work history of the new user; and
data indicating information related to family members of the new user.

20. The computer-readable medium of claim 16, wherein the analytics module includes one or more of:
a clustering predictive model;
a classification predictive model;
a decision tree predictive model;
a collaborative filter; and
a correlation model produced with a computer learning algorithm.

21. The computer-readable medium of claim 16, wherein the one or more sources of tax information include one or more of:
armed services;
state institutions;
federal institutions;
private employers;
financial institutions;
financial management service providers; and
social media.

22. The computer-readable medium of claim 16, wherein the tax return preparation engine is configured to preemptively populate the tax return of the new user with the new user tax data by enabling the analytics module to determine the relationship between the new user metadata and the one or more sources of tax information without receiving a request from the user to determine the relationship between the new user metadata and the one or more sources of tax information.

23. A system for gathering user tax data for a user, from one or more sources of tax information, to prepare a tax return of the user within a tax return preparation system, the system comprising:
at least one processor; and
at least one memory coupled to the at least one processor, the at least one memory having stored therein instructions which, when executed by any set of the one or more processors, perform a process for gathering user tax data for a user, from one or more sources of tax information, to prepare a tax return of the user within a tax return preparation system, the process including:
populating a database with relationships between existing user metadata and one or more sources of tax information,
wherein the existing user metadata is metadata of multiple users who have completed tax returns with a tax return preparation system;
receiving new user metadata for a new user of the tax return preparation system;
analyzing the new user metadata for the new user to identify which of the one or more sources of tax information are relevant to the new user metadata of the new user, based on the relationships between the existing user metadata and the one or more sources of tax information;
retrieving new user tax data from the identified ones of the one or more sources of tax information that are relevant to the new user metadata of the new user; and
populating a tax return of the new user with the new user data, within the tax return preparation system.

24. The system of claim 23, wherein retrieving the new user tax data from the identified ones of the one or more sources of tax information includes preemptively receiving the new user data.

25. The system of claim 24, wherein preemptively receiving the new user data from the identified ones of the one or more sources of tax information includes retrieving the new user tax data, without receiving a request to retrieve the new user tax data from the new user.

26. The system of claim 25, wherein preemptively receiving the new user data from the identified ones of the one or more sources of tax information includes populating the tax return of the new user with the new user data, without receiving a request from the new user to populate the tax return of the new user with the new user data.

27. The system of claim 23, wherein new user metadata excludes data that is directly input into the tax return of the new user.

28. The system of claim 23, wherein the new user metadata includes one or more of:
data indicating a geographic location of the new user;
data indicating an industry in which the new user is employed;
data indicating a job function of the new user;
data indicating an educational background of the new user;
data indicating an age of the new user;
data indicating a work history of the new user; and
data indicating information related to family members of the new user.

29. The system of claim 23, wherein the new user metadata is generated from information that is indirectly provided to the tax return preparation system by the new user.

30. The system of claim 23, wherein the new user metadata is generated from information that is directly provided to the tax return preparation system by the user.

31. The system of claim 23, wherein the new user tax data includes one or more of:
data indicating a name of the new user;
data indicating Social Security Number of the new user;
data indicating a government identification of the new user;
data indicating a date of birth of the new user;
data indicating an address of the new user;
data indicating a zip code of the new user;
data indicating a home ownership status of the new user;
data indicating a marital status of the new user;
data indicating an annual income of the new user;
data indicating an employer's address of the new user;
data indicating spousal information of the new user;
data indicating children's information of the new user;
data indicating assets of the new user;
data indicating a medical history of the new user;
data indicating an occupation of the new user;
data indicating dependents of the new user;
data indicating a salary and wages of the new user;
data indicating an interest income of the new user;
data indicating a dividend income of the new user;
data indicating a business income of the new user;
data indicating a farm income of the new user;
data indicating a capital gain income of the new user;
data indicating a pension income of the new user;
data indicating IRA distributions of the new user;
data indicating an unemployment compensation of the new user;
data indicating educator expenses of the new user;
data indicating health savings account deductions of the new user;
data indicating moving expenses of the new user;
data indicating IRA deductions of the new user;
data indicating student loan interest deductions of the new user;
data indicating tuition and fees of the new user;
data indicating medical and dental expenses of the new user;
data indicating state and local taxes of the new user;
data indicating real estate taxes of the new user;
data indicating personal property tax of the new user;
data indicating mortgage interest of the new user;
data indicating charitable contributions of the new user;
data indicating casualty and theft losses of the new user;
data indicating unreimbursed employee expenses of the new user;
data indicating an alternative minimum tax of the new user;
data indicating a foreign tax credit of the new user;
data indicating education tax credits of the new user;
data indicating retirement savings contributions of the new user;
data indicating child tax credits of the new user; and
data indicating residential energy credits of the new user.

32. The system of claim 23, wherein the one or more sources of tax information that correspond with the new user are associated, in the database, with the existing user metadata that is similar to the new user metadata.

33. The system of claim 23, wherein the multiple users have completed tax returns with the tax return preparation system for one or more previous tax years.

34. The system of claim 23, wherein the process further comprises:
directing the existing user metadata and the one or more sources of tax information through an analytics algorithm to determine the relationships between the existing user metadata and one or more sources of tax information.

35. The system of claim 34, wherein the analytics algorithm includes one or more of:
a clustering predictive model;
a classification predictive model;
a decision tree predictive model;
a collaborative filter; and
a correlation model produced with a computer learning algorithm.

36. The system of claim 34, wherein the analytics algorithm is interchangeably implemented within the tax return preparation system to enable the analytics algorithm to be exchanged with one or more other analytics algorithms.

37. The system of claim 23, wherein the one or more sources of tax information include one or more of:
armed services;
state institutions;
federal institutions;
private employers;
financial institutions;
financial management service providers; and
social media.
